(19) United States
(12) Patent Application Publication
(10) Pub. No.: US 2026/0370477 A1
(43) Pub. Date: Nov. 19, 2026

(54) PHI-CLOCK MESH AND SLOT-ISSUANCE PROTOCOL FOR LEDGER-BALANCED PULSE NETWORKS

(71) Applicant: Jonathan Washburn, Austin, TX (US)

(72) Inventor: Jonathan Washburn, Austin, TX (US)

(21) Appl. No.: 19/676,391

(22) Filed: May 13, 2026

Related U.S. Application Data
(60) Provisional application No. 63/805,958, filed on May 14, 2025.

(51) Int. Cl. H04L 9/32; H04L 9/00

(52) U.S. Cl. CPC H04L 9/3213; H04L 9/3218; H04L 9/3247; H04L 9/50

(57) ABSTRACT

A Phi-clock mesh and slot-issuance protocol operates a mesh network of synchronized clock nodes. The nodes generate or receive a common beat clock, group eight beats into a transmission slot, and issue cryptographic slot tokens according to a supply rule based on accumulated uptime. Each slot token authorizes transmission of one eight-sub-burst pulse train during a corresponding slot. Signed integrals of the sub-bursts are required to satisfy a balance condition at a slot boundary within a defined tolerance. Proof-of-balance data may include a Merkle root and digital signature associated with the signed integrals. Unused, expired, imbalanced, or unverifiable tokens are deterministically burned without carry-forward. Timing-drifting nodes may be quarantined by decentralized consensus when at least three neighboring nodes detect drift exceeding a threshold under a defined drift metric and decision rule. The protocol supports tamper-evident audit records, proof-backed timing relationships, and ledger-balanced pulse-network operation.

### CROSS-REFERENCE TO RELATED APPLICATIONS

This application claims the benefit of U.S. Provisional Patent Application No. 63/805,958, filed May 14, 2025, the entire contents of which are incorporated herein by reference.

### BACKGROUND OF THE INVENTION

The present disclosure relates generally to distributed timing systems, mesh-network medium-access protocols, cryptographically authenticated transmission scheduling, pulse-network coordination, and ledger-based communication control. More particularly, the disclosure relates to a Phi-clock mesh protocol in which synchronized clock nodes generate a common beat cadence, group a fixed number of beats into transmission slots, issue cryptographic slot tokens, verify algebraic balance of transmitted pulse trains, deterministically burn unused or imbalanced tokens, and quarantine timing-drifting nodes using decentralized neighbour consensus.

Conventional time-slotted channel-access protocols can assign transmission windows to network nodes, but generally treat each slot as an opaque communication interval. Such systems do not require the waveform or pulse train transmitted during a slot to satisfy an algebraic neutrality condition at a slot boundary. Conventional systems also do not typically bind a slot right to a finite-supply cryptographic token that is automatically erased if unused, expired, imbalanced, or invalid.

Existing mesh timing systems may rely on centralized time masters, administrative overrides, or root-key authority. These approaches can create single points of failure and can permit timing faults, spoofing, unauthorized slot use, or compromised timing references to propagate through the network. The discussion of any technology, protocol, system, or limitation in this background section is provided for technical context and does not constitute an admission that any feature, combination of features, problem, motivation, or reference was known, conventional, material, or prior art. A need exists for a distributed protocol in which clock discipline, token issuance, slot use, balance verification, deterministic burn, and quarantine enforcement are algorithmic, auditable, and resistant to unilateral override.

A further need exists for a pulse-network protocol in which an eight-sub-burst transmission satisfies a balance condition at each slot boundary, and in which the balance condition can be compactly verified by neighbouring nodes using cryptographic proofs rather than replaying an entire waveform. A further need exists for a mesh protocol that combines disciplined timing, deterministic slot-token economics, proof-of-balance verification, tamper-evident audit records, and decentralized quarantine of timing-drifting nodes.

Unlike conventional time-slot assignment systems, the disclosed protocol does not merely reserve a communication interval. In preferred embodiments, permission to use a slot remains conditional on verification that the emitted pulse train satisfies a slot-boundary ledger-balance rule. Thus, a slot right, a measured physical waveform, a cryptographic proof, and a deterministic burn outcome are linked in the same protocol state transition.

### SUMMARY OF THE INVENTION

In one aspect, the disclosure provides a method of operating a mesh network of Phi-clock nodes. Each node is synchronized to a common beat clock. In preferred embodiments, the beat period is 6.25 microseconds and eight consecutive beats define a 50 microsecond slot.

In another aspect, the protocol mints slot tokens according to a supply rule S=alpha*P, where P is accumulated uptime and alpha is a governance-set proportionality constant. Each slot token grants permission to transmit one eight-sub-burst pulse train in a corresponding slot window.

In another aspect, the eight-sub-burst pulse train is required to satisfy a ledger-balance condition within a defined tolerance. Signed integrals I_k of the sub-bursts satisfy a balance test such that an absolute value of a sum of the signed integrals is less than or equal to epsilon times I_ref at the slot boundary. The balance condition is motivated by the Recognition Science eight-tick cancellation identity sum_{k=0}\hat{ }7 exp(2pii*k/8)=0.

In another aspect, a slot token includes a token header, a Merkle root computed from the eight signed integrals or proof data derived from them, and a digital signature. In preferred embodiments, the token is 128 bytes and includes a 32-byte header, a 32-byte Merkle root, and a 64-byte Ed25519 signature.

In another aspect, the protocol deterministically burns tokens. A token is burned if it is unused at slot expiry, expired at an epoch boundary, associated with an imbalanced pulse train, or fails verification. No partial credit, carry-forward, or administrative override is provided.

In another aspect, timing drift is handled by decentralized quarantine. If at least three neighbouring nodes detect drift exceeding a threshold, the drifting node is quarantined for a predetermined exclusion period, preferably 24 hours. A quarantined node may be prevented from minting or spending slot tokens while still being permitted to receive and verify network traffic.

In another aspect, a Phi-clock node includes a disciplined oscillator, beat generator, slot counter, balance checker, cryptographic engine, token pool, burn register, audit-chain module, drift monitor, and mesh-radio interface.

In another aspect, formal-verification artifacts provide machine-checkable support for mathematical and protocol-consistency properties, including eight beats per slot, slot-period calculation, beat-rate calculation, token-size calculation, issuance positivity, balance implying zero net integral, quarantine at a three-witness threshold, no quarantine below the threshold, tamper-evident audit-chain behavior, and eight-tick phase cancellation.

### BRIEF DESCRIPTION OF THE DRAWINGS

FIG. 1 illustrates an overall Phi-clock mesh protocol architecture. The figure shows how synchronized Phi-clock nodes cooperate to issue slot tokens, authorize ledger-balanced pulse transmissions, verify proof-of-balance data, deterministically burn invalid or unused tokens, quarantine timing-drifting nodes, and record token outcomes in an audit chain.

FIG. 2 illustrates a beat-clock and slot-timing architecture. The figure shows a disciplined timing reference driving a beat generator, a beat clock, and a modulo-8 slot counter so that eight consecutive beats define a transmission slot and a slot boundary.

FIG. 3 illustrates a slot-token format. The figure shows a token header, node identifier, timestamp, slot index, epoch, nonce, Merkle-root field, digital-signature field, token-size boundary, and associated proof-packet data used to authenticate a slot transmission.

FIG. 4 illustrates a proof-of-balance verification structure. The figure shows eight signed pulse integrals, a tolerance-based balance check, Merkle-tree construction, Merkle-root comparison, digital-signature verification, and verification-result routing.

FIG. 5 illustrates an issuance and deterministic-burn workflow. The figure shows uptime-based token issuance, token-pool storage, slot assignment, committed-token routing, imbalanced-token burn, unused-token burn, expired-token burn, no-carry-forward enforcement, and audit-chain recording.

FIG. 6 illustrates a Phi-clock node hardware architecture. The figure shows a disciplined oscillator, FPGA beat-generation logic, modulo-8 slot counter, balance checker, token pool, burn register, cryptographic engine, audit-chain module, drift monitor, mesh-radio transceiver, and application pulse driver.

FIG. 7 illustrates a broadcast and attestation workflow. The figure shows pulse-script composition, pre-verification, USE-packet transmission, scheduled slot emission, local integral measurement, token signing, attestation-packet broadcast, neighbour verification, FLAG generation, commit routing, burn routing, and quarantine escalation.

FIG. 8 illustrates a consensus-quarantine state machine. The figure shows normal node operation, neighbour drift detection, accumulation of first, second, and third drift flags, quarantine triggering, minting disablement, transmission disablement, receive-and-verify operation, resynchronization, quarantine timing, and return to normal operation.

FIG. 9 illustrates a mesh topology and neighbour-verification arrangement. The figure shows multiple mesh nodes, mesh links, neighbour witness groups, multi-hop relay paths, token-attestation paths, FLAG propagation paths, and a quarantine-consensus region.

FIG. 10 illustrates formal-verification and audit support for the Phi-clock mesh protocol. The figure shows proof dependencies for eight-tick cancellation, beat rate, slot period, token size, balance, issuance positivity, quarantine thresholds, slot-boundary neutrality, mirror neutrality, hash-chain tamper evidence, ledger-syndrome support, and a master viability certificate.

### DETAILED DESCRIPTION OF THE INVENTION

The following description provides examples and embodiments of the disclosed technology. The examples are intended to provide written-description and enablement support and are not intended to limit the scope of the claims unless a limitation is expressly recited. The core invention is a Phi-clock mesh and slot-issuance protocol in which synchronized clock nodes generate a common beat cadence, group beats into fixed transmission slots, issue cryptographically authenticated slot tokens, enforce ledger-balanced pulse transmission at slot boundaries, deterministically burn unused, expired, imbalanced, or unverifiable tokens, record committed and burned token outcomes in a tamper-evident audit structure, and quarantine timing-drifting nodes through decentralized neighbour consensus. These functions cooperate as an integrated access-control and pulse-network discipline: timing determines eligible slot windows, slot tokens authorize use of those windows, proof-of-balance verifies admissible pulse use, deterministic burn prevents carry-forward or invalid credit, the audit chain records outcomes, and neighbour consensus prevents unilateral timing exclusion or centralized override.

As used herein, “Phi-clock node” means a network node configured to generate or receive a disciplined beat clock and to participate in slot issuance, slot use, balance verification, deterministic burn, audit logging, and drift monitoring.

As used herein, “beat” means a timing interval generated from a disciplined clock. In preferred embodiments, each beat has a period of 6.25 microseconds.

As used herein, “slot” means a transmission window comprising a fixed group of beats. In preferred embodiments, eight consecutive beats form one slot having a period of 50 microseconds.

As used herein, “slot token” means a cryptographic authorization data structure granting permission to transmit during a corresponding slot window. In preferred embodiments, a slot token includes a header, Merkle root, and digital signature.

As used herein, “ledger-balanced pulse train” means a pulse train comprising a plurality of sub-bursts whose signed integrals satisfy a ledger-balance condition at a slot boundary. In an ideal mathematical form, the ledger-balance condition corresponds to zero net signed integral over the slot, such that sum_{k=0}∂I_k=0 for eight sub-bursts. In practical measurement embodiments, the same ledger-balance condition may be evaluated within a defined measurement tolerance to account for integrator resolution, quantization, baseline offset, pulse-driver noise, clock jitter, or other implementation error. In preferred embodiments, the pulse train includes eight sub-bursts having signed integrals I_0 through I_7, and the measured balance condition is satisfied when an absolute value of a sum of the signed integrals satisfies |sum_{k=0}\hat{ }7 I_k|<=epsilon*I_ref, where epsilon is a tolerance selected based on measurement resolution and noise, and I_ref is a reference integral magnitude. The tolerance-based test is a practical verification rule for the underlying ledger-balance requirement and is not intended to remove the slot-boundary neutrality requirement.

As used herein, “proof-of-balance” means data sufficient to verify that signed integrals of a transmitted pulse train satisfy the ledger-balance condition under a defined integration rule. In preferred embodiments, signed integrals I_k are computed over an integration window associated with each beat, for example from a beat edge to a next beat edge or over a defined sub-window within the beat, optionally after baseline subtraction. The proof-of-balance includes or is associated with (i) data representing the signed integrals, encoded values derived from the signed integrals, or cryptographic leaf data derived from them, (ii) a determination that the signed integrals satisfy the ledger-balance condition, either exactly as sum_{k=0}∂I_k=0 or within a defined measurement tolerance such as |sum_{k=0}\hat{ }7 I_k|<=epsilon*I_ref, and (iii) a Merkle root computed from cryptographic leaf values derived from the signed integrals or encoded proof data, such that a receiving node can recompute the Merkle root and verify consistency with a slot token.

As used herein, “deterministic burn” means algorithmic erasure, invalidation, or retirement of a slot token without partial credit, carry-forward, grace period, or administrative override.

As used herein, “epoch” means an issuance interval used for token minting, expiration, auditing, or quarantine accounting. In preferred embodiments, an epoch is one wall-clock hour.

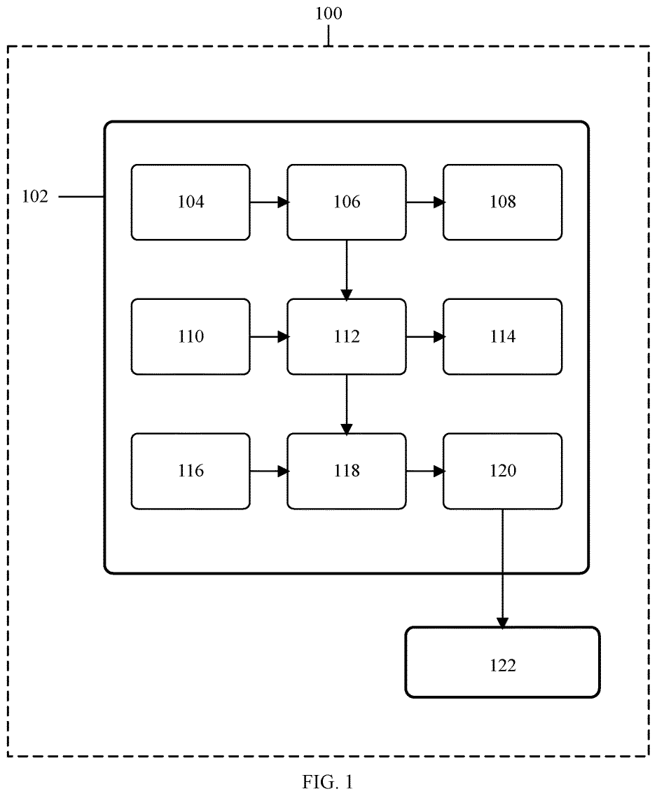

FIG. 1 depicts a Phi-clock mesh protocol system 100. The system 100 includes a plurality of Phi-clock nodes 102. Each node may include or communicate with a disciplined oscillator 104, beat generator 106, slot counter 108, token issuance module 110, proof-of-balance module 112, deterministic burn module 114, quarantine module 116, audit-chain module 118, mesh-radio interface 120, and application pulse medium 122. In operation, the nodes cooperate to distribute transmission rights, verify balanced pulse trains, and maintain a tamper-evident record of committed and burned token outcomes.

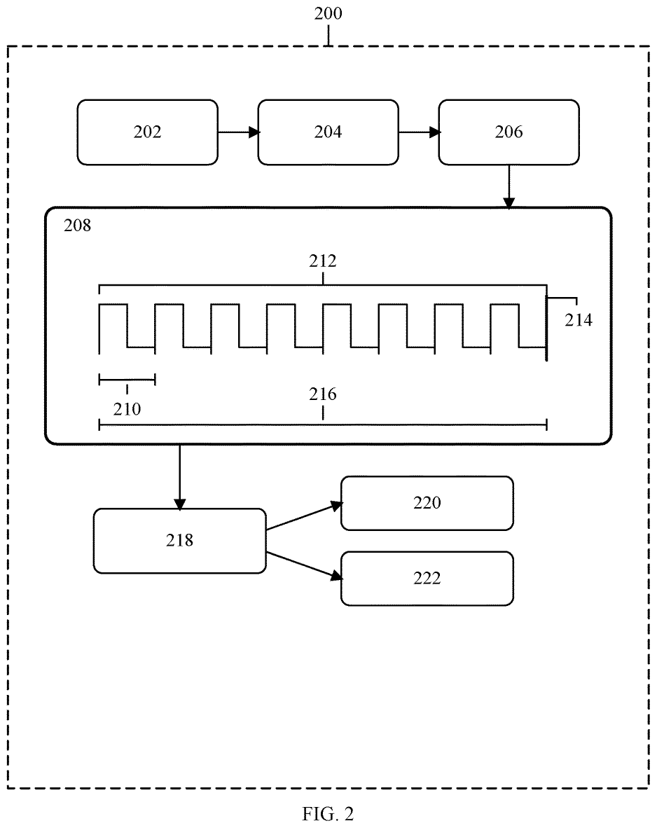

FIG. 2 depicts a timing architecture 200. A GPS 1-PPS reference 202 disciplines a disciplined oscillator 204. In preferred embodiments, the disciplined oscillator comprises a 10 MHz oven-controlled crystal oscillator having Allan deviation less than 1×10\hat{ }−11 at 1 second averaging time. An FPGA divider 206 generates a beat clock 208 having a beat period 210 of 6.25 microseconds, corresponding to 160,000 beats per second. Eight consecutive beats form an eight-beat group 212. A slot boundary 214 is asserted after the eighth beat, thereby defining a slot period 216 of 50 microseconds and a slot rate of 20,000 slots per second. A modulo-8 counter 218 may maintain a beat count within the slot, and the node may associate each slot with a slot index 220 and epoch hour 222.

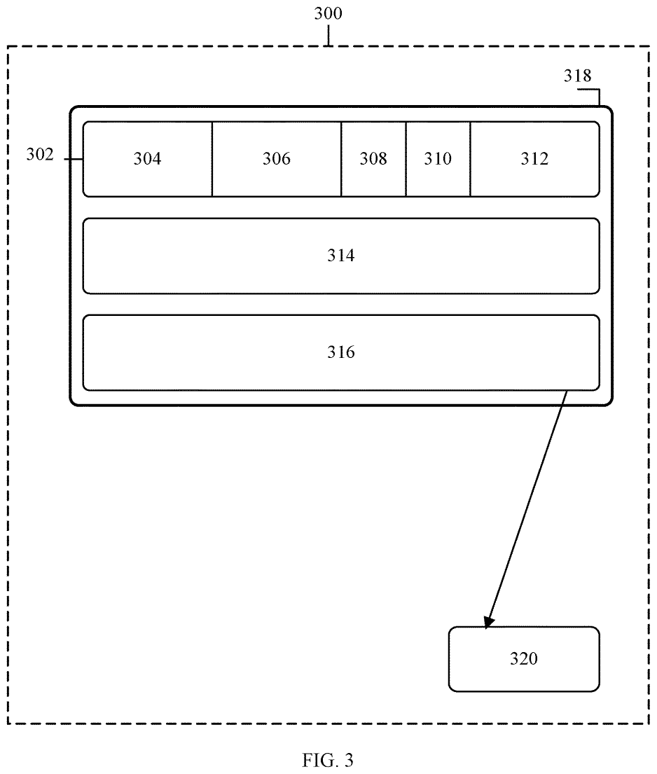

FIG. 3 depicts a slot token 300. The slot token 300 includes a token header 302. In preferred embodiments, the header includes a node identifier field 304, timestamp field 306, slot-index field 308, epoch field 310, and nonce field 312. In one embodiment, the node identifier is 8 bytes, the timestamp is 8 bytes, the slot index is 4 bytes, the epoch is 4 bytes, and the nonce is 8 bytes, producing a 32-byte header. The token further includes a Merkle-root field 314 and a signature field 316. In one embodiment, the token has a 128-byte token boundary 318 comprising the 32-byte header, a 32-byte SHA-256 Merkle root, and a 64-byte Ed25519 signature. The token may be associated with proof packet data 320 carrying the eight signed integrals or sufficient leaf data to recompute the Merkle root.

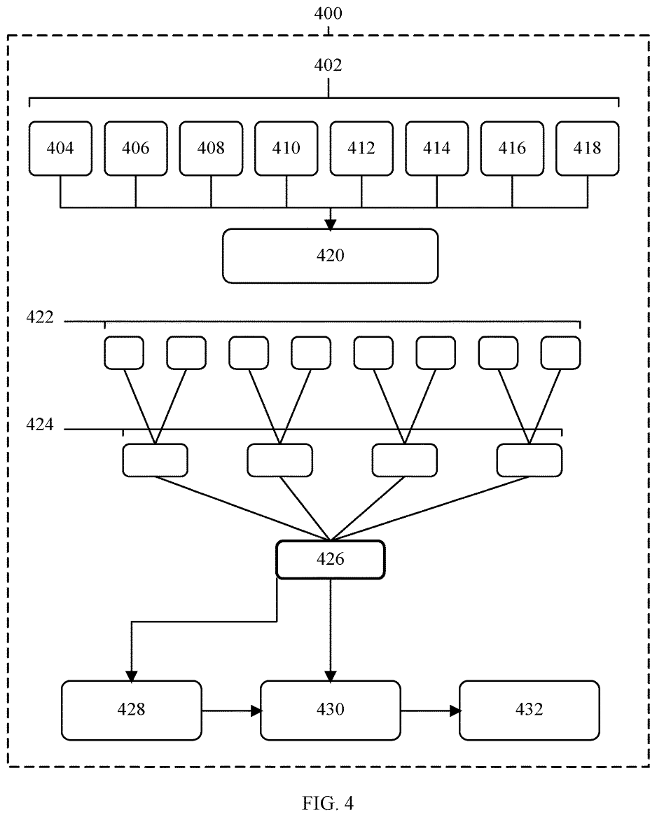

FIG. 4 depicts a proof-of-balance structure 400. The proof-of-balance structure includes signed integrals 402 corresponding to the eight sub-bursts of a pulse train. The signed integrals may include first through eighth integrals 404, 406, 408, 410, 412, 414, 416, and 418. A balance check 420 determines whether the signed integrals satisfy the balance condition within the defined tolerance, for example by determining whether an absolute value of a sum of the signed integrals satisfies |sum_{k=0}\hat{ }7 I_k|<=epsilon*I_ref. Merkle leaves 422 are generated from the signed integrals or from encoded data representing the signed integrals, internal hash nodes 424 are computed, and a Merkle root 426 is produced. In a preferred binary Merkle tree, the eight leaves require seven internal hash operations. A receiving node performs a token-root comparison 428, signature verification 430, and verification-result routing 432. If the recomputed root does not match the token root, or if the signature fails, the receiving node may broadcast a fault indication.

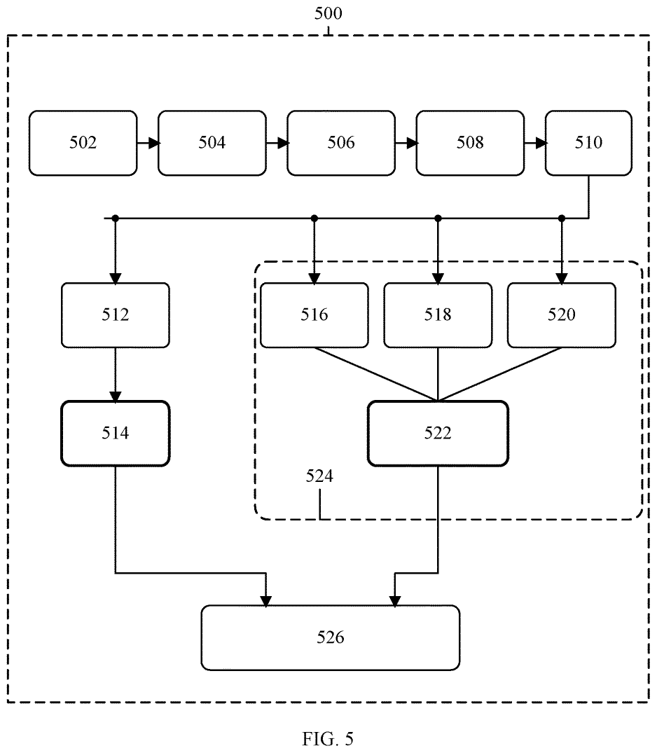

FIG. 5 depicts an issuance and deterministic-burn workflow 500. An uptime accumulator 502 stores accumulated uptime P for a node. A proportionality constant 504, represented by alpha, is used in a token supply calculation 506. In one embodiment, the number of issued tokens satisfies S=alpha*P. In a preferred embodiment, alpha defaults to 1000 tokens per uptime hour, although another governance-set proportionality constant may be used. Issued tokens are stored in a token pool 508 and associated with slot assignment 510. A balanced-use path 512 routes a valid balanced token to a committed-token outcome 514. An imbalanced-token path 516, unused-token path 518, and expired-token path 520 route invalid, unused, or expired tokens to a deterministic burn outcome 522. A no-carry-forward boundary 524 prevents unused tokens from being retained for future slots. In preferred embodiments, no borrowing from future epochs and no debt accumulation are permitted. An audit-chain record 526 stores committed and burned outcomes.

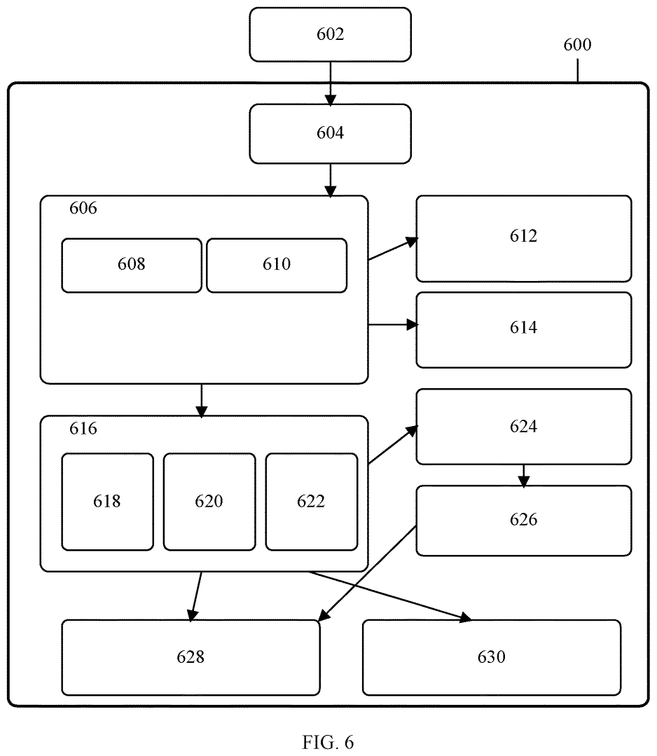

FIG. 6 depicts a Phi-clock node 600. The node may include a GPS input 602, disciplined oscillator 604, beat-generator FPGA logic 606, modulo-8 slot counter 608, balance checker 610, token pool memory 612, burn register 614, cryptographic engine 616, SHA-256 module 618, Blake3 module 620, Ed25519 module 622, audit-chain module 624, drift monitor 626, mesh-radio transceiver 628, and application pulse driver 630. In preferred embodiments, timing-critical beat and slot functions are performed in FPGA logic, while cryptographic token construction, verification, and audit-chain operations may be performed by a microcontroller or secure processor. In one implementation, the cryptographic engine comprises an ARM Cortex-M33 processor with TrustZone-M isolation and hardware acceleration for SHA-256, Blake3, and Ed25519.

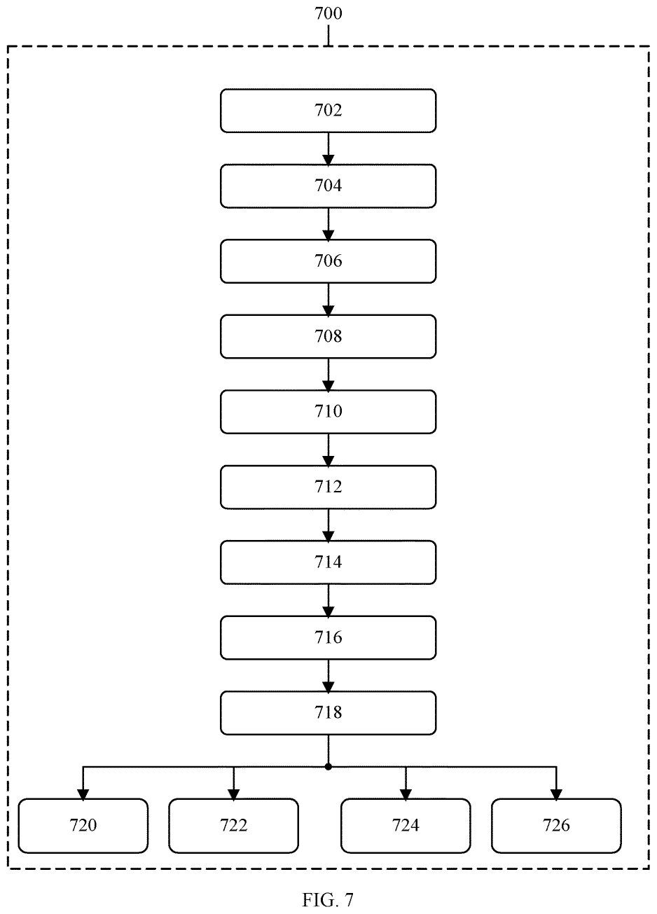

FIG. 7 depicts a broadcast workflow 700. A node performs pulse-script composition 702 before a target slot. A pre-verification step 704 checks the balance condition before transmission. A USE packet 706 may be transmitted over a mesh radio to announce intended use of a scheduled slot window 708. In preferred embodiments, the USE packet is a 32-byte control-plane packet identifying an intended future slot. During the slot, the node performs eight-sub-burst emission 710. A local integral measurement 712 measures the signed integrals of the emitted sub-bursts. A token signing step 714 generates a signed token or attestation. An attestation packet 716 is broadcast for neighbour verification 718. The attestation packet may include the 128-byte token plus the eight signed integrals or equivalent Merkle leaf data sufficient for third-party recomputation of the Merkle root. Verification failure may result in a FLAG packet 720. Verification success routes the token through a commit path 722, while invalidity routes it through a burn path 724. Repeated failures may enter a quarantine escalation path 726.

The USE packet, attestation packet, FLAG packet, and quarantine packet may be transmitted on a mesh control plane that is separate from the application pulse medium. The 50 microsecond slot window governs the timing of the eight-sub-burst pulse transmission, while cryptographic announcements, balance attestations, and audit traffic may be pipelined on a slower control plane subject to mesh-link capacity. For example, a sub-GHz LoRa mesh radio operating at 200 kbit/s may carry sparse USE packets, attestations, and audit messages without carrying every possible per-slot transaction at the full 20,000 slots-per-second physical slot rate.

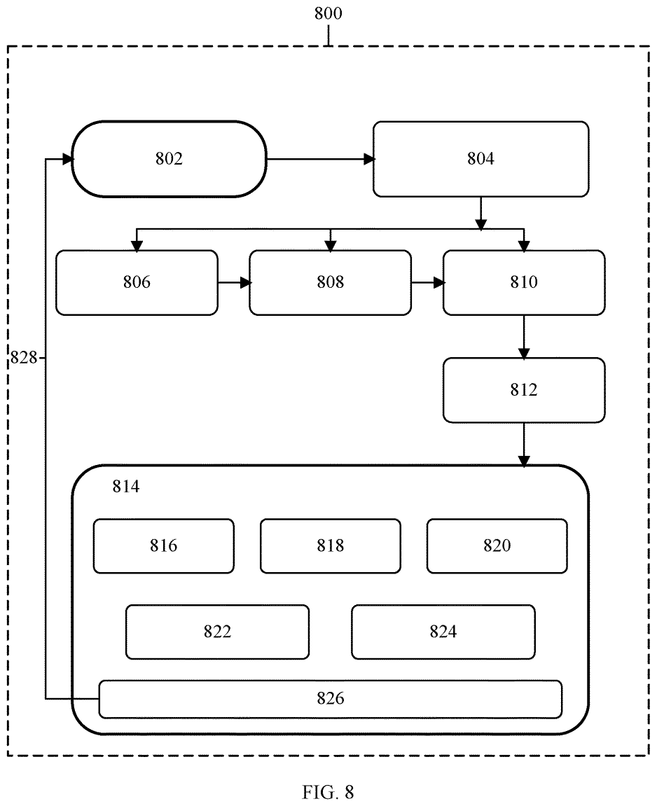

FIG. 8 depicts a quarantine state machine 800. A node begins in a normal node state 802. Neighbouring nodes perform drift detection 804 by comparing observed beat edges against local disciplined timing. A first neighbour flag 806 and second neighbour flag 808 do not alone trigger quarantine. A third neighbour flag 810 satisfies the quarantine threshold and produces a quarantine trigger 812. The affected node enters a quarantined node state 814. During quarantine, minting may be disabled at 816 and transmission may be disabled at 818, while receive-and-verify operation 820 may remain permitted. The node may satisfy a resynchronization condition 822 and a quarantine-duration timer 824. In preferred embodiments, the quarantine duration is 24 hours. When a quarantine-lift condition 826 is met, the node follows a return-to-normal path 828.

In preferred embodiments, the quarantine-lift condition includes expiration of the quarantine duration and verification by neighbouring nodes that the node has returned within the permitted timing-drift threshold.

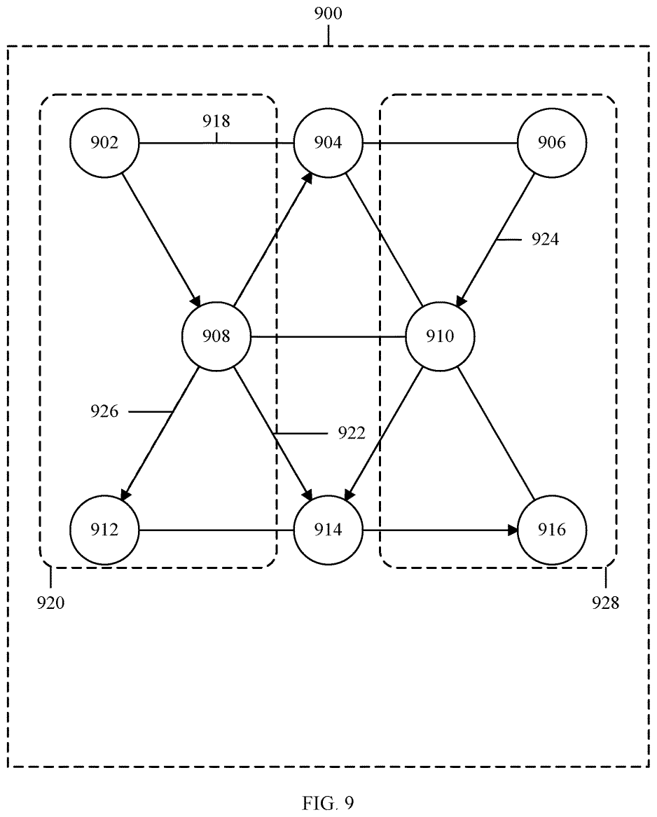

FIG. 9 depicts a mesh topology 900 including first through eighth nodes 902, 904, 906, 908, 910, 912, 914, and 916. Mesh links 918 connect the nodes. A neighbour witness group 920 may observe timing drift or verification failures. A multi-hop relay path 922 may carry control-plane information. A token attestation path 924 distributes token and proof data. A FLAG propagation path 926 distributes fault indications. A quarantine consensus region 928 represents the local set of neighbouring nodes sufficient to trigger decentralized quarantine. In preferred embodiments, no single node can unilaterally quarantine another node. The three-witness requirement reduces malicious or accidental exclusion by a single faulty neighbour.

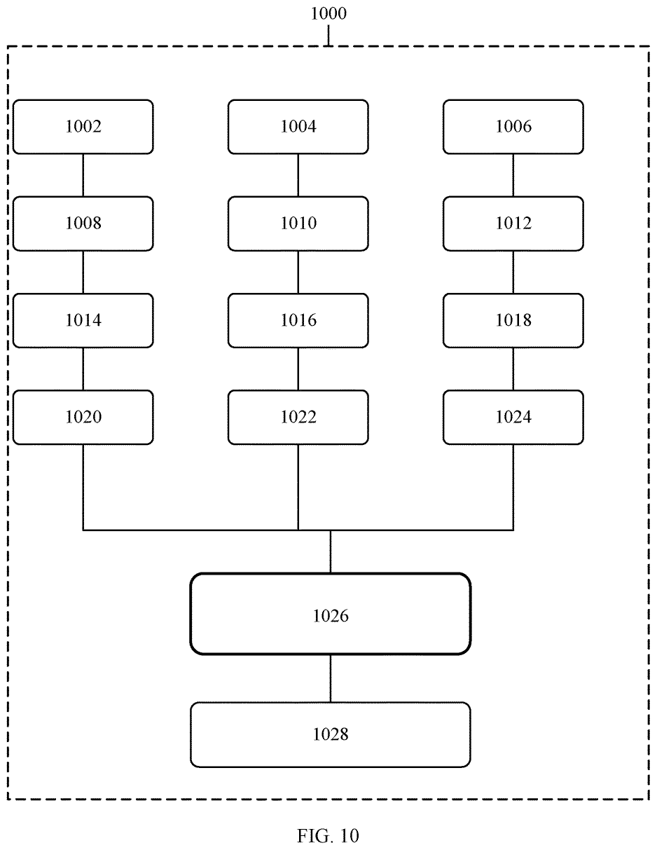

FIG. 10 depicts a verification architecture 1000. The verification architecture may include an eight-tick identity proof 1002, beat-rate proof 1004, slot-period proof 1006, token-size proof 1008, balance-implies-zero-net proof 1010, issuance-positivity proof 1012, quarantine-at-three proof 1014, no-quarantine-below-three proof 1016, slot-boundary-neutrality proof 1018, mirror-neutrality proof 1020, hash-chain tamper-evidence proof 1022, ledger-syndrome bridge 1024, master viability certificate 1026, and protocol implementation output 1028. Formal verification supports mathematical and protocol-consistency properties and does not replace empirical testing of radio performance, oscillator drift, packet loss, cryptographic latency, or application-layer pulse effects.

In one preferred timing embodiment, the beat clock has a period of 6.25 microseconds, the beat rate is 160,000 beats per second, eight beats form one slot, the slot period is 50 microseconds, and the slot rate is 20,000 slots per second. A 3-bit modulo-8 counter may increment on each beat and roll over from 7 to 0 at each slot boundary. The rollover may assert a slot-boundary signal used to evaluate balance, expire slot tokens, commit valid tokens, burn invalid tokens, and advance the slot index.

In one preferred token embodiment, the token header is 32 bytes, the Merkle root is 32 bytes, and the digital signature is 64 bytes, producing a 128-byte slot token. The header may include an 8-byte node identifier, 8-byte timestamp, 4-byte slot index, 4-byte epoch field, and 8-byte nonce. The digital signature may comprise an Ed25519 signature over the header and Merkle root. SHA-256 may be used for Merkle-tree construction and audit hashes, while Blake3 may be used for beat-level integrity, node heartbeats, or other high-throughput integrity checks.

In one deterministic-burn embodiment, a token is committed only if the associated pulse train satisfies the ledger-balance condition and the cryptographic proof verifies. A token is burned if the pulse train is imbalanced, the token is unused at slot expiry, the token is older than an allowed epoch, the Merkle root fails verification, the digital signature fails verification, or the token otherwise fails a required slot-validity check. Burn is deterministic and non-discretionary: a burned token is erased, invalidated, or retired without partial credit, carry-forward, grace period, retroactive cure, borrowing from a future epoch, debt accumulation, administrative override, root-key exception, or exception handler. The audit chain may record each token outcome as COMMITTED or BURNED.

In embodiments using a slot-validity check, the slot-validity check is defined by protocol configuration before the corresponding slot window opens. The check may include one or more of: token expiration status, token-slot correspondence, node quarantine status, Merkle-root match, digital-signature verification, proof-of-balance verification, permitted epoch, permitted node identifier, permitted slot index, permitted nonce status, and compliance with the defined measurement tolerance. A token is not treated as invalid based on a retroactively created condition or discretionary administrative decision.

In one trust-minimized governance embodiment, protocol enforcement is algorithmic and auditable. A node is not permitted to override deterministic burn, manufacture retroactive credit, bypass balance verification, or unilaterally quarantine another node. In preferred embodiments, the mesh protocol operates without a root key, without a privileged administrative override, and without a “god mode” capable of exempting a node from burn or quarantine rules.

In one quarantine embodiment, a drifting node is quarantined only after at least three neighbouring nodes detect timing drift exceeding a threshold, where the timing drift is evaluated using a defined drift metric and decision rule. In one embodiment, each neighbouring node computes a drift metric D as a phase error between an observed beat edge of the target node and an expected beat edge based on the neighbour's disciplined timing, expressed in time units, and generates a drift flag when D exceeds a phase threshold Theta for at least M consecutive beats. In one implementation, Theta is selected in a range from 0.1 microseconds to 5 microseconds and M is selected in a range from 8 to 1024 beats to reduce false quarantine due to transient interference. In another embodiment, the drift metric D is a frequency error over a window of N beats, and the drift flag is generated when an absolute value of the frequency error exceeds a frequency threshold for at least one or more consecutive windows. In one implementation, N is selected in a range from 64 to 4096 beats. In another embodiment, the drift metric is Allan deviation over a defined averaging interval, and the drift flag is generated when the Allan deviation exceeds a specified Allan-deviation threshold at the averaging interval. The foregoing drift metrics, thresholds, windows, and numerical ranges are illustrative implementation choices for generating drift flags and are not intended to limit the broader decentralized quarantine mechanism unless expressly recited in a claim. The three-neighbour quarantine requirement, the quarantine-duration concept, and decentralized enforcement are preserved regardless of the particular drift metric used. The quarantined node is prevented from minting or transmitting for a quarantine duration, such as 24 hours, may continue to receive and verify network traffic, and may return to normal operation after the quarantine duration has elapsed and the node has resynchronized within the drift threshold under the same or another defined drift metric. In preferred embodiments, fewer than three drift detections do not trigger quarantine.

In one cryptographic-timing embodiment, SHA-256 may be computed on a 128-byte input in less than 2 microseconds, Ed25519 signing may occur in less than 8 microseconds, and Ed25519 verification may occur in less than 12 microseconds. In one implementation, total per-token cryptographic overhead is less than about 22 microseconds or less than about 23.5 microseconds including Merkle-tree operations. Cryptographic operations may be pipelined and need not be completed inside the 50 microsecond pulse-emission slot when the slot emission itself is governed by FPGA timing logic.

In one hardware embodiment, the Phi-clock node includes a GPS-disciplined 10 MHz oven-controlled crystal oscillator, FPGA beat generator, modulo-8 slot counter, balance checker, ARM Cortex-M33 cryptographic engine, hardware SHA-256, Blake3, Ed25519 support, token-pool memory, burn register, audit-chain storage, drift monitor, and sub-GHz LoRa mesh-radio transceiver operating at about 200 kbit/s. In another embodiment, a rubidium oscillator may support GPS-denied operation. In a preferred GPS-denied embodiment, the rubidium oscillator has Allan deviation less than 5×10\hat{ }−12 at 1 second and maintains timing drift below 1 microsecond over an extended interval.

In one control-plane capacity embodiment, a LoRa radio rate of 200 kbit/s corresponds to about 25,000 bytes per second. A 128-byte token would consume about 128 bytes of that capacity, while a 32-byte USE packet is smaller and may be used for sparse scheduling announcements. The control plane is therefore suitable for USE packets, attestations, FLAG packets, quarantine packets, and audit messages in low-duty-cycle or scheduled operation, even where it is not used to carry every physical slot transaction at the full slot rate.

In preferred embodiments, USE packets and attestations may be scheduled, queued, batched, or transmitted ahead of the physical slot to which they correspond. Failure to deliver a control-plane packet within an applicable verification window may cause the associated token to be burned or left uncommitted, but does not alter the locally generated beat clock or the physical timing of the eight-sub-burst emission.

In one preferred proof embodiment, the transmitting node measures or computes signed integrals for eight sub-bursts over defined integration windows associated with the beats, applies any defined baseline subtraction, and evaluates the ledger-balance condition. In an ideal form, the slot-level algebraic balance corresponds to sum_{k=0}\hat{ }7 I_k=0. In practical measurement embodiments, the node may evaluate the same balance requirement using a tolerance such that |sum_{k=0}\hat{ }7 I_k|<=epsilon*I_ref. In one implementation, epsilon is selected in a range from 10\hat{ }−6 to 10\hat{ }−2 depending on integrator resolution, ADC noise, and expected pulse amplitude, and I_ref is selected as (i) a mean absolute integral across the eight sub-bursts, (ii) a maximum absolute integral among the eight sub-bursts, or (iii) a fixed calibration integral derived from a reference pulse. These example values illustrate implementation choices for objectively evaluating measured balance and do not alter the ledger-balance requirement, proof-of-balance structure, or deterministic-burn enforcement described herein. When the balance test is satisfied, the node computes Merkle leaves from the signed integrals or encoded integral data, computes internal hash nodes, places the resulting Merkle root in the token, and signs the token. A receiving node recomputes the Merkle root from the provided integral data or Merkle leaf data, compares it to the token root, verifies the signature, and broadcasts a fault indication if verification fails. The balance condition may be motivated by the eight-tick phase cancellation identity sum_{k=0}\hat{ }7 exp(2pii*k/8)=0, while practical slot-level verification may use exact equality, tolerance-based equality, calibrated equality, or another defined balance decision rule.

In preferred embodiments, the measurement tolerance, reference integral, integration window, and baseline-subtraction rule are fixed before evaluation of the corresponding slot. The same tolerance rule is applied by the transmitting node and by verifying neighbouring nodes. This prevents a node from satisfying the balance condition by changing the tolerance after emission. In one implementation, the protocol configuration identifies whether I_ref is a mean absolute integral, a maximum absolute integral, or a fixed calibration integral derived from a reference pulse.

In one audit-support embodiment, an immutable ledger hash chain records token outcomes. The hash chain may append each COMMITTED or BURNED outcome using SHA-256 chaining. In one implementation, hash_chain_tamper_evident is identified as a proved property associated with audit-chain behavior. A ledger syndrome bridge, including syndrome_iff_admissible and ledgerSyndrome, may connect admissibility of balance proofs to an information-theoretic verification framework.

Formal verification, as described herein, supports mathematical identities, timing arithmetic, token-size arithmetic, balance implications, issuance positivity, quarantine thresholds, audit-chain consistency, and master viability relationships. References to particular proof names, modules, theorem labels, or verification artifacts identify examples of machine-checkable support and do not require that every implementation use the same proof-assistant environment, file structure, theorem name, module name, or verification toolchain unless expressly recited in a claim. Formal verification does not itself establish all empirical performance characteristics of a deployed network. Empirical validation may include measuring oscillator drift, beat jitter, packet loss, radio throughput, cryptographic latency, pulse-integral measurement accuracy, false quarantine rate, audit-chain storage performance, and application-layer pulse effects.

The eight-tick cancellation identity and Recognition Science terminology provide a mathematical and architectural motivation for the disclosed eight-sub-burst structure. Implementations of the protocol do not require adoption of any particular physical interpretation of Recognition Science.

The operative engineering requirements are the beat grouping, slot-boundary balance test, proof-of-balance verification, deterministic burn rule, audit recording, and decentralized quarantine logic described herein.

In one therapeutic pulse-network embodiment, a plurality of Phi-clock nodes coordinate optical pulse delivery. Each slot token authorizes one ledger-balanced eight-sub-burst optical exposure.

In one example, a treatment space includes 8 to 32 ceiling-mounted nodes, each having an optical emitter such as a GaN micro-LED array. Deterministic burn may prevent unused or imbalanced exposure rights from carrying forward, and an audit chain may record committed and burned treatment events.

In one industrial timing-fabric embodiment, a plurality of Phi-clock sensor nodes coordinate time-slotted reporting in an industrial environment. Sensor data may be encoded as eight-sub-burst amplitudes satisfying the balance condition, thereby providing inherent error detection and deterministic access timing. The 50 microsecond slot period can provide bounded access timing for process-control, monitoring, or sensor-reporting applications.

In one secure-communication embodiment, a plurality of Phi-clock nodes coordinate balanced pulse messaging over directional radio-frequency or free-space optical links. The balance condition, Merkle proof, and signature verification provide authentication and fault detection, while consensus quarantine limits propagation of timing faults or compromised nodes. In GPS-denied embodiments, rubidium oscillators and peer-to-peer beat alignment may maintain slot timing.

In one autonomous-vehicle embodiment, vehicle-mounted nodes and roadside nodes exchange slot-token-authorized messages for vehicle-to-vehicle or vehicle-to-infrastructure coordination. Priority functions may allocate more slot tokens to higher-risk vehicle states, while Merkle verification and quarantine reduce spoofing and timing-fault propagation. An audit chain may record committed and burned vehicle-message tokens.

In additional embodiments, the same protocol architecture may be applied to smart-grid coordination, distributed energy resource management, precision agriculture, blockchain validator timing, or other systems requiring deterministic time-slotted access, cryptographic authorization, balance verification, auditability, and decentralized quarantine. These downstream embodiments are illustrative deployment environments for the Phi-clock mesh and slot-issuance protocol. They use the protocol as a component, coordination layer, timing substrate, access-control layer, or verification layer and do not redefine or limit the core protocol unless a particular deployment feature is expressly recited in a claim. Features described in connection with one deployment environment may be combined with features described in another deployment environment when technically compatible.

What is claimed is:

1. A method of operating a slot-based medium-access protocol for a mesh network of Phi-clock nodes, comprising:
(a) synchronizing a plurality of Phi-clock nodes to a common beat clock;
(b) grouping eight consecutive beats of the common beat clock into a transmission slot;
(c) issuing cryptographic slot tokens to at least one of the Phi-clock nodes according to a token supply rule based on accumulated uptime of the Phi-clock node;
(d) associating each slot token with permission to transmit one eight-sub-burst pulse train during a corresponding transmission slot;
(e) determining signed integrals of sub-bursts of the pulse train;
(f) verifying proof-of-balance data associated with the signed integrals; and
(g) enforcing, at a slot boundary of the corresponding transmission slot, a ledger-balance condition corresponding to zero net signed integral over the pulse train, wherein the ledger-balance condition is evaluated exactly or within a defined measurement tolerance;
wherein a slot token associated with an unused, expired, imbalanced, unverifiable, or otherwise invalid pulse train is deterministically burned without carry-forward.

2. The method of claim 1, wherein each beat has a period of 6.25 microseconds and each transmission slot has a period of 50 microseconds.

3. The method of claim 1, wherein the token supply rule is S=alpha*P, where S is a number of issued slot tokens for an issuance epoch, alpha is a governance-set proportionality constant, and P is accumulated uptime of the Phi-clock node.

4. The method of claim 1, wherein the pulse train comprises eight sub-bursts having signed integrals I_0 through I_7, wherein the ledger-balance condition corresponds, in an ideal mathematical form, to sum_{k=0}\hat{ }7 I_k=0, and wherein, in a practical measurement embodiment, the ledger-balance condition is satisfied when an absolute value of a sum of the signed integrals is less than or equal to epsilon times I_ref, where epsilon is a measurement tolerance and I_ref is a reference integral magnitude.

5. The method of claim 1, further comprising generating the proof-of-balance data by computing cryptographic leaf values from data representing the signed integrals or encoded values derived from the signed integrals, constructing a Merkle tree from the cryptographic leaf values, and placing a resulting Merkle root in or in association with the slot token so that a receiving Phi-clock node can recompute the Merkle root and verify consistency between the proof-of-balance data and the slot token.

6. The method of claim 5, wherein a slot token comprises a token header, the Merkle root, and a digital signature.

7. The method of claim 6, wherein the slot token comprises a 32-byte header, a 32-byte Merkle root, and a 64-byte Ed25519 signature.

8. The method of claim 1, further comprising deterministically burning a slot token when the slot token is unused at slot expiry, expired at an epoch boundary, associated with an imbalanced pulse train, associated with a Merkle-root mismatch, associated with a digital-signature failure, associated with failed proof-of-balance verification, or otherwise fails a required slot-validity check.

9. The method of claim 8, wherein deterministically burning the slot token prevents partial credit, carry-forward, borrowing from a future epoch, or debt accumulation.

10. The method of claim 1, further comprising appending committed and burned token outcomes to a tamper-evident audit chain using hash chaining in which each audit-chain entry depends on a prior audit-chain entry and a current token outcome, thereby producing an auditable record of slot-token commitment and deterministic-burn events.

11. A Phi-clock node for a ledger-balanced pulse network, comprising:
(a) a disciplined oscillator; (b) beat-generation logic configured to generate a beat clock; (c) a slot counter configured to group eight beats into a transmission slot and identify a slot boundary; (d) a token-management module configured to store cryptographic slot tokens; (e) a balance checker configured to determine whether signed integrals of an eight-sub-burst pulse train satisfy a ledger-balance condition exactly or within a defined measurement tolerance; (f) a cryptographic engine configured to construct or verify proof-of-balance data comprising a Merkle root and a digital signature associated with a slot token; (g) a deterministic-burn module configured to erase, invalidate, or retire unused, expired, imbalanced, unverifiable, or otherwise invalid slot tokens; (h) an audit-chain module configured to record committed and burned token outcomes; (i) a drift monitor configured to detect timing drift of neighboring clock nodes; and(j) a communication interface configured to transmit or receive mesh-network control messages.

12. The Phi-clock node of claim 11, wherein the disciplined oscillator comprises a GPS-disciplined 10 MHz oven-controlled crystal oscillator having Allan deviation less than 1×10\hat{ }−11 at 1 second averaging time.

13. The Phi-clock node of claim 11, wherein the beat-generation logic comprises FPGA logic configured to generate 160,000 beats per second, each beat having a period of 6.25 microseconds.

14. The Phi-clock node of claim 11, wherein the slot counter comprises a modulo-8 counter configured to assert a slot-boundary signal after every eighth beat, thereby defining a transmission slot having a period of 50 microseconds.

15. The Phi-clock node of claim 11, wherein the balance checker is configured to compute or receive signed integrals I_0 through I_7 for the eight-sub-burst pulse train and to determine whether the signed integrals satisfy the ledger-balance condition by evaluating zero net signed integral exactly or by evaluating whether an absolute value of a sum of the signed integrals is within the defined measurement tolerance.

16. The Phi-clock node of claim 11, wherein the token-management module comprises token-pool memory configured to store slot tokens for at least one issuance epoch, and wherein the deterministic-burn module comprises a burn register configured to erase, invalidate, or retire unused, expired, imbalanced, or unverifiable slot tokens without carry-forward.

17. A Phi-clock mesh network system comprising:
(a) a plurality of Phi-clock nodes, each configured to generate or receive a common beat clock; (b) a slot-issuance protocol configured to issue cryptographic slot tokens to the Phi-clock nodes according to accumulated uptime; (c) a proof-of-balance protocol configured to verify that signed integrals of sub-bursts of an authorized pulse train satisfy a ledger-balance condition at a slot boundary exactly or within a defined measurement tolerance; (d) a deterministic-burn protocol configured to retire unused, expired, imbalanced, unverifiable, or otherwise invalid slot tokens; (e) an audit-chain protocol configured to record committed and burned token outcomes in a tamper-evident audit structure; and (f) a consensus-quarantine protocol configured to quarantine a timing-drifting Phi-clock node in response to drift detections from at least three neighboring Phi-clock nodes, wherein each drift detection is based on a defined drift metric exceeding a drift threshold under a decision rule; wherein the Phi-clock nodes independently verify balance proofs and enforce slot-token validity without central authority.

18. The Phi-clock mesh network system of claim 17, wherein the consensus-quarantine protocol disables token minting and pulse transmission by the quarantined Phi-clock node for a quarantine period of 24 hours while permitting the quarantined Phi-clock node to receive and verify network traffic, and wherein a quarantine-lift condition includes expiration of the quarantine period and a determination, using the defined drift metric or another defined drift metric, that the Phi-clock node has returned within an applicable drift threshold.

19. The Phi-clock mesh network system of claim 17, wherein the Phi-clock mesh network system enforces slot-token validity, deterministic burn, and consensus quarantine without a root key, privileged administrative override, god mode, exception handler, unilateral quarantine authority, retroactive token credit, or carry-forward of burned or unused slot tokens.

20. The Phi-clock mesh network system of claim 17, wherein mesh-network control messages comprise USE packets announcing intended slot use, attestation packets carrying a slot token and integral data or Merkle leaf data, FLAG packets reporting verification failure, and quarantine packets reporting quarantine status, and wherein the mesh-network control messages are transmitted on a control plane separate from an application pulse medium used for the eight-sub-burst pulse train.
